(19) United States
(12) Patent Application Publication
(10) Pub. No.: US 2006/0197914 A1
(43) Pub. Date: Sep. 7, 2006

(54) Four panel projection system

(75) Inventor: Michael G. Robinson, Boulder, CO (US)

Correspondence Address: BAKER & MCKENZIE LLP;PATENT DEPARTMENT, 2001 ROSS AVENUE, SUITE 2300, DALLAS, TX, 75201, US

(73) Assignee: Colorlink, Inc., Boulder, CO (US)

(21) Appl. No.: 11/367,956

(22) Filed: Mar. 3, 2006

Related U.S. Application Data
(60) Provisional application No. 60/658,455, filed on Mar. 4, 2005.

(51) Int. Cl. G03B 21/14

(52) U.S. Cl. 353/20

(57) ABSTRACT

A four-panel liquid-crystal-on-silicon (LCOS) projection display system utilizes four available ports of a beam splitter and polarization filter architecture to provide a four-color component image with an increased brightness and color gamut compared with typical three-color component images. The projection display system includes a light source, four light modulating panels, a light directing subsystem, and a projection lens. The light source is operable to generate light having four color components. Each of the four light modulators is operable to generate a respective image associated with the respective one of the four color components. The light directing subsystem is operable to split the four color components before modulation and recombine them after modulation, and each light modulator is located at a separate port of the light directing subsystem. The projection lens is operable to project an image of the modulated combined color components.

### CROSS REFERENCE TO RELATED APPLICATIONS

This Application claims the benefit of U.S. Provisional Application Ser. No. 60/658,455, filed on Mar. 4, 2005, and entitled “Four Panel Architecure,” which is commonly assigned with the present application and incorporated herein by reference.

### BACKGROUND

1. Technical Field

The present disclosure relates to a four panel projection system used in a projection type display.

2. Description of Related Art

It is generally desirable for projection systems to produce high quality images while being compact and inexpensive. Conventional three-color display systems are known that provide projection of red, green, and blue color components. However, a drawback of such conventional three-color display systems is that they are inherently limited to the triangular color gamut defined by saturated RGB primaries, which in the case of video projection systems, force the bright yellow emission of UHP lamps to be discarded.

FIG. 5 illustrates a known architecture 500 that has been successfully employed with conventional three-panel RGB displays. Architecture 500 is a liquid crystal on silicon (LCOS) system using four polarizing beam splitters (PBSs) with wavelength selective polarization filters. Such filters may be ColorSelect™ retarder stack filters, as described in U.S. Pat. No. 5,751,384, which is hereby incorporated by reference for all purposes. Such an architecture 500 uses an input cube 502 to split-off a single primary band, a shared PBS 504 to split and recombine between two panels 506-508, a single cube 510 to separate input and output beams from a single panel 512, and a fourth output cube 514 to recombine all three colors effectively performing the inverse of the input cube 502. The retarder stack filters 516-522 selectively transform the polarization of one color band relative to its complement and are known to be used with PBSs to form color splitting and combining systems for use with reflective LCOS panels.

Another drawback of such systems is that color balance is often sacrificed to improve brightness of the projected image. For color displays, one aspect of picture quality is color temperature. This is a subjective evaluation, indicated by the “whiteness” of white. Color balance has been achieved conventionally by providing additional filtering to decrease the intensity of particular color components, thus correcting any imbalance in the light source. However, because image brightness is already a problem in conventional display systems, it is often undesirable to further decrease brightness in order to achieve a more desirable color temperature.

Accordingly, it would be desirable to utilize additional primary colors, or a different set of primary colors in a projection system to increase the color gamut, and to increase brightness of the projection system.

### BRIEF SUMMARY

Disclosed herein is a four panel architecture that provides a four-primary color based projection system. For instance, four primary color components that may be used with this system include red, yellow, green, and blue. Including yellow light as a fourth primary has several advantages that address the deficiencies of three-panel systems discussed above. First, color brightness is increased due to an increased transmitted throughput using the otherwise-discarded yellow light from a UHP light source. Second, color gamut is increased because the availability of four primary color components allows a chromatic reproduction not available to conventional three-primary color based systems. In particular, the primary green color can be a much richer green.

According to an aspect of the disclosure, a projection display system includes a light source, an input beam splitter, a first, second, and a third PBS, and a projection lens. The light source is operable to generate light having a first, second, third, and a fourth color component. The input beam splitter is operable to direct the first and second color components on a first light path, and the third and fourth color components on a second light path. The first PBS has an input port to receive light from the first light path. The first PBS directs the first color component toward a first panel, and directs the second color component toward a second panel. A second PBS has an input port to receive light from the second light path. The second PBS directs the third color component toward a third panel, and directs the fourth color component toward a fourth panel. The third PBS receives the first and second color component at a first input port, and receives the third and fourth color component at a second input port. The third PBS directs the first, second, third, and fourth color components toward an output port, where a projection lens projects an image from the color components.

According to another aspect of the disclosure, the projection display system includes a light source, four light modulating panels, a light directing subsystem, and a projection lens. The light source is operable to generate light having four color components. Each of the four light modulators is operable to generate a respective image associated with the respective one of the four color components. The light directing subsystem is operable to split the four color components before modulation and recombine them after modulation, and each light modulator is located at a separate port of the light directing subsystem. The projection lens is operable to project an image of the modulated combined color components.

### BRIEF DESCRIPTION OF THE DRAWINGS

The disclosure will be described in detail with reference to the following drawings in which like reference numerals refer to like elements wherein:

FIG. 1 is a diagram that illustrates an embodiment of a four panel projection system in accordance with the present disclosure;

FIG. 2 is a graph illustrating the normalized power output of an exemplary UHP lamp through an ultraviolet filter for a range of electromagnetic frequencies in accordance with the present disclosure;

FIG. 3 is a graph illustrating the normalized transmission against wavelength for various wavelength-selective color filters, as used in the exemplary embodiment of FIG. 1;

FIG. 4 illustrates a graph showing modified color space for simulated system color gamuts in accordance with the present disclosure; and

FIG. 5 is a diagram of a known architecture that has been employed with three-panel RGB displays.

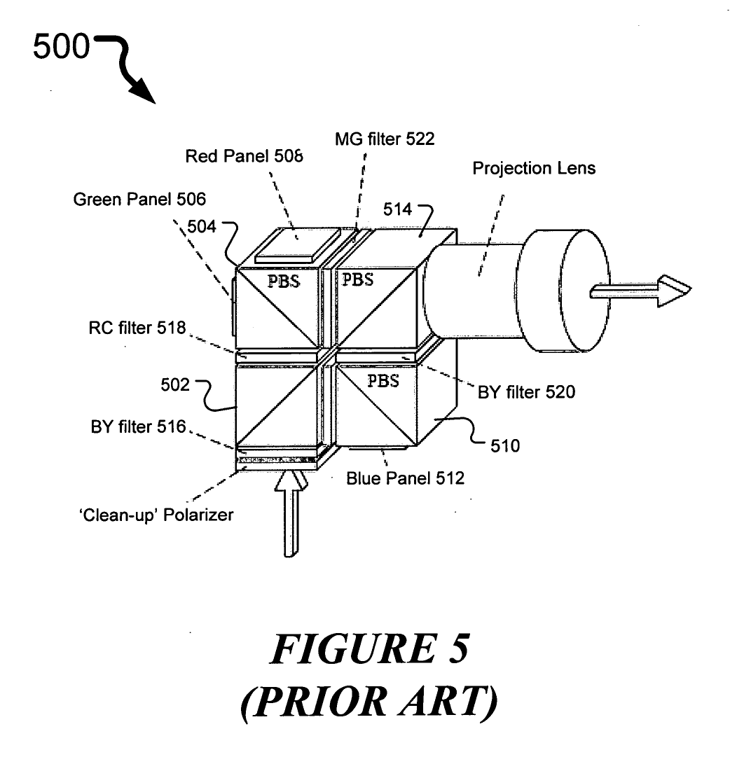

### DETAILED DESCRIPTION

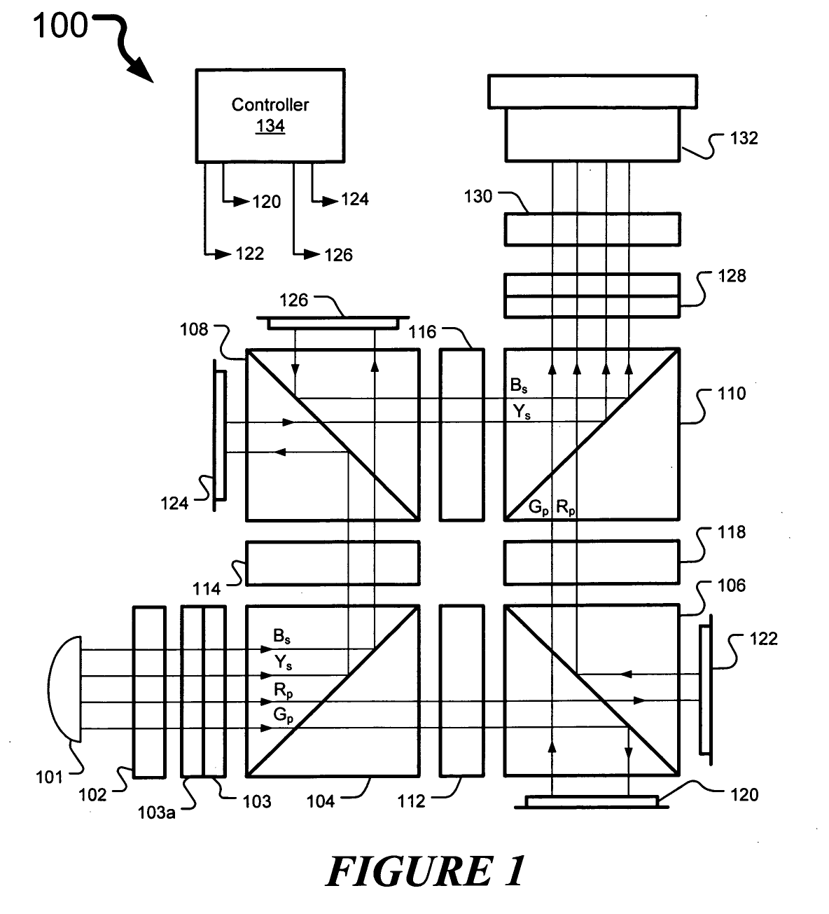

FIG. 1 is a diagram that illustrates an embodiment of a four panel projection system 100. The four panel projection system 100 includes a light source 101, a pre-polarizer 102, wavelength-selective polarization filters 103, 103a, 112-118, an input beam splitter 104, polarizing beam splitters (PBS) 106-110, LCOS reflective panels 120-126, projection lens 132, and controller 134, arranged as shown. The four panel projection system 100 may also include exit wavelength-selective polarization filters 128a, 128, and/or polarization filter 130.

Light source 101 may be a standard UHP mercury illumination source, metal-halide source, a light emitting diode-based light source, a laser-based light source, a xenon light source, or any other light source that generates visible spectra with a plurality of color components. Controller 134 may provide control signals to panels 120-126 to modulate the respective color components with color component image information. Controller 134 may also adjust each of the control signals to vary the intensity of the reflected color components for panels 120-126, thus providing an adjustment to the color component balance. Input beam splitter 104 may be a PBS, or alternatively, a double pass band dichroic mirror. The wavelength-selective polarization filters 103, 103a, 112-118, and 128 may be retarder stack filters (RSFs) that selectively transform the polarization of one or more color components. Examples of wavelength-selective polarization filters include ColorSelect™ filters, which rotate the polarization of predetermined spectra to the orthogonal polarization, while leaving the state of polarization of other spectra unchanged. ColorSelect™ filters may be obtained from Colorlink, Inc. in Boulder, Colo. Wavelength selective polarization filters 103, 103a, 112-118, and 128 may be used with PBSs 106-110 (and also 104, if 104 is a PBS) to form color splitting and combining systems for use with reflective LCOS panels 120-126. Generally, the wavelength selective polarization filters facilitate all four ports of a PBS to be used to split and combine input and output light between two color-specific panels.

As used herein, a color component refers to a different color or spectral bandwidth, for example, red, blue, yellow, and green light components. In this exemplary embodiment, the first color component may be green, the second may be red, the third may be yellow, and the fourth color component may be blue. However, it is to be understood that any set of wavelength ranges may be used for the color components, and/or arranged in a different order, as desired. The wavelength ranges of the different color components may or may not overlap with one another. As will be discussed in detail herein, this color combination provides an optimum combination of increased brightness and color gamut. Also, as used herein, the term ‘direct,’ when used with reference to an input beam splitter or a polarization beam splitter component refers to transmitting and/or reflecting light at an interface.

In operation, light from light source 101 is incident on a ‘p’ polarizer 102, e.g., a wire grid polarizer, which pre-polarizes light into the system with ‘p’ polarization. A yellow notch filter 103a may be positioned between polarizer 102 and polarizer 103. Polarization filter 103 which then follows, may be a blue/yellow filter. Thus, the combination of polarization filters 103a and 103 provides a mixed filter with pass and stop bands that are configured to alter yellow and blue (third and fourth) color components to an ‘s’ polarized state. In this manner, an input beam splitter 104 may be used on input light from light source 101 to split off the first and second color component toward PBS 106, and also split off the third and fourth color component toward PBS 108. The different polarization states are preferably at 900 orientations, such as ‘s’ and ‘p’ linearly orthogonal polarization states, but may be at any other suitable angle or relationship, as desired. Also, right and left-handed circular polarization states may be used.

The first and second color components are processed as follows. Polarization filter 112 transforms the polarization of the first color component (e.g., green) to ‘s’-polarization, which is substantially orthogonal to the second color component (e.g., red) in ‘p’-polarization. PBS 106 divides the light into two polarization components, reflecting the ‘s’-polarized component at an interface while transmitting the ‘p’-polarized component. Thus, the interface of PBS 106 reflects the first color component with ‘s’-polarization toward a first panel 120. PBS 106 transmits the second color component, which has ‘p’-polarized light, toward a second panel 122 by allowing the transmission of p-polarized light through the interface. When in the ON-state, the polarization state of reflected first component light from the first panel 120 is transformed from ‘s’ to ‘p’ polarization, thus the reflected light from the first panel 120 will be transmitted through the boundary of PBS 106 toward polarization filter 118. Similarly, when in the ON-state, reflected second color component light from the second panel 122 will be in an ‘s’ polarization, so it will reflect at the interface toward polarization filter 118. Accordingly, this scheme combines the modulated first and second color components.

The third and fourth color components are processed in a similar manner. For instance, polarization filter 114 transforms the polarization of the third color component (e.g., yellow) to ‘s’-polarization, which is substantially orthogonal to the fourth color component (e.g., blue) in ‘p’-polarization. PBS 108 reflects the third color component with ‘s’-polarization toward a third panel 124 by reflecting the ‘s’-polarized light at the interface. PBS 108 transmits the fourth color component, which has ‘p’-polarized light, toward a fourth panel 126 by allowing the transmission of ‘p’-polarized light through the interface. In the ON-state, light reflected from the third panel 124 is altered from ‘s’ to ‘p’ polarization, thus the reflected light from the panel will be transmitted through the interface of PBS 108 toward polarization filter 116. Similarly, reflected fourth color component light from the fourth panel 126 in the ON-state is altered to ‘s’ polarization, so it will reflect at the interface toward polarization filter 116. Accordingly, this scheme combines the modulated third and fourth color components.

PBS 110 combines the first, second, third, and fourth color components and directs them toward projection lens 132. Polarization filter 118, which receives the first color component in a ‘p’ polarization and the second color component in an ‘s’ polarization, may transform the polarization of the second color component to a ‘p’-polarization in order that the first and second color components are transmitted at the boundary of PBS 110 toward projection lens 132. In other embodiments the other output port of PBS 110 may be used—in which case, the polarization filter 118 will be selected to transform the first color component to an ‘s’ polarization such that the first and second color components will be reflected at the boundary layer of PBS 110. Now, with regard to the third and fourth color components, polarization filter 116 will be selected to transform the third color component from ‘p’ to ‘s’ polarization. Or in other embodiments using the other output port, polarization filter 116 will be selected to transform the fourth color component from ‘s’ to ‘p’ polarization. Accordingly, the modulated first, second, third, and fourth color components are be combined, and directed toward projection lens 132.

Although the other output port on PBS 110 may be used to provide a parallel input/output configuration, it is desirable to have the color component panel for green (e.g., panel 120) facing the projection lens, as this offers reduced aberrations and better imaging. Additionally, although the other input port on input beam splitter 104 may be used, it is desirable to have all the panels positioned relative to the output of the system to optimize the clean polarization into the photopically richer green and red channels. Also, by choosing this 90° input/output configuration, the yellow and blue color component throughputs are maximized, which is beneficial in delivering the largest color-balanced output brightness.

A general characteristic of many PBSs is that at an interface, very little ‘s’-polarized light is transmitted, but a reasonable amount of ‘p’ polarized light will be reflected when it should ideally be transmitted through the interface. Due to this characteristic, the modulated fourth color component, which is modulated by panel 126 (in this example, the blue color component), is not well analyzed by the PBSs, so when all panels 120-126 are in the OFF-state, it is likely that the fourth color component will leak, providing an undesirable blue color observed in the projector's OFF-state. Accordingly, three ways of addressing this problem are addressed below. A first approach to minimizing this undesirable OFF-state fourth color component (blue) leakage involves using a chromatic (e.g., blue only) output polarizer 130 as an exit analyzer to remove the stray ‘p’ polarized fourth color component. A second approach involves using wavelength-selective polarization filters 128a and 128, where filter 128a is similar to filter 103a and filter 128 is similar to filter 103 (e.g., a combination of a yellow notch filter and a blue/yellow filter). Alternatively, a third approach involves using high-performance analyzing PBSs, i.e., those with low reflection of polarized light at one spectral band, to eliminate the need for using filters 128a, 128, and/or 130.

It should be appreciated that although FIG. 1 shows one possible embodiment, the inventive concept can easily be expanded to include many incremental variations. For example, PBS depolarization and skew ray correction of some degree may be used with this four panel architecture, consistent with the principles described in U.S. Pat. No. 6,816,309, which is hereby incorporated by reference for all purposes. Another variation that may be employed is the use of a hybrid polarization beam splitter configuration that overcomes the reflected wave distortion associated with conventional PBSs while maintaining excellent polarization performance, consistent with the principles disclosed in U.S. Provisional Pat. App. No. 60/717,134, and is hereby incorporated by reference for all purposes.

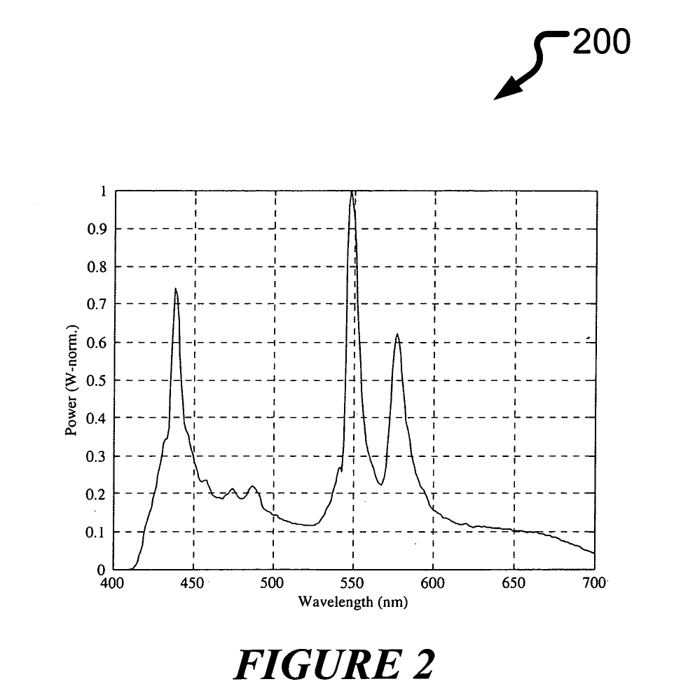

FIG. 2 shows a spectrum 200 of an exemplary UHP illumination source 101 of FIG. 1 through a UV filter. As shown by the spectrum, the light from UHP illumination source 101 is essentially white, the output is somewhat red deficient and green rich. In a three-panel RGB system, typically the peaked nature of this spectrum requires precise color management, particularly to remove the unwanted yellow spike around 580 nm. However, the four-panel RYGB described herein utilizes the otherwise discarded yellow emission around 580 nm, thus increasing system brightness and color gamut.

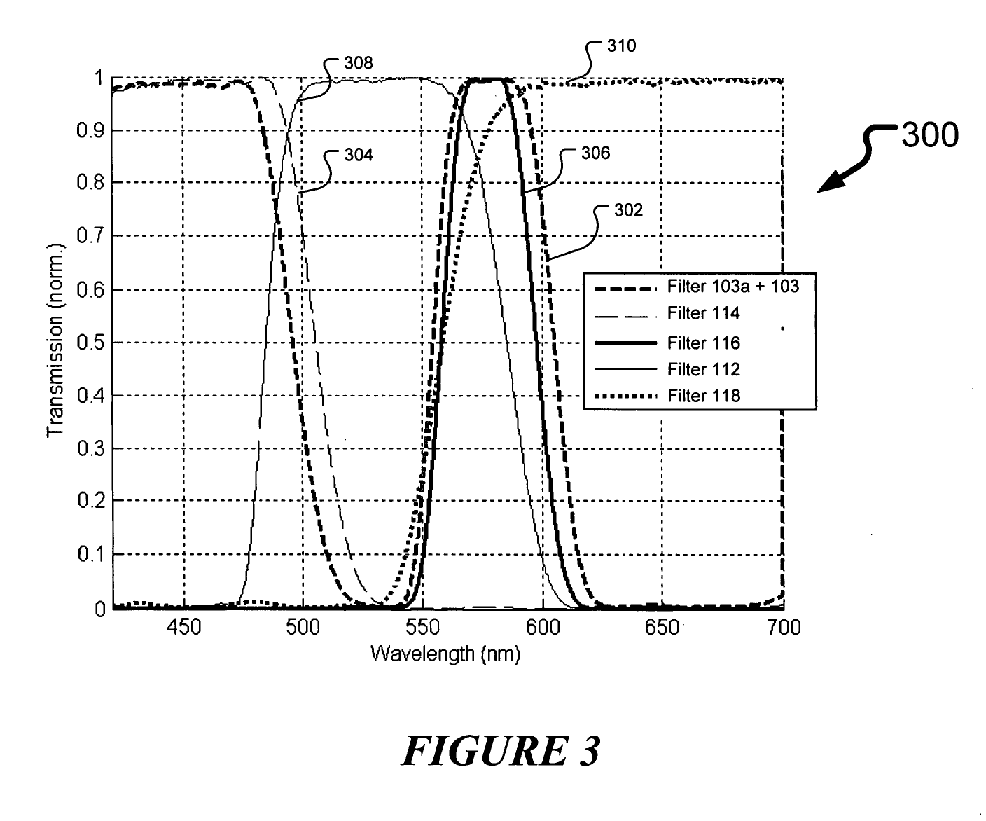

FIG. 3 is a graph 300 illustrating the normalized transmission against wavelength for various wavelength-selective color filters 103a, 103, 112-118, 128a, and 128 as used in the exemplary embodiment of FIG. 1. For instance, line 302 shows that filter 103a and 103 (and filter 128a and 128), in combination provide a mixed retarder film filter with pass and stop bands that are configured to allow or deny yellow and blue color components from passing depending on whether the polarization filters are in a crossed or parallel configuration. Line 304 illustrates the normalized transmission spectrum for filter 114 of FIG. 1, which in that exemplary embodiment is a blue/yellow filter. Line 306 shows the normalized transmission spectrum for filter 116 of FIG. 1, which in that example embodiment is a yellow notch filter. Filter 112 of the exemplary embodiment of FIG. 1, which is a green/magenta filter, has a normalized transmission spectrum shown by line 308. And filter 118 of FIG. 1 is a yellow/blue filter, having a normalized transmission spectrum illustrated by line 310. Such spectral characteristics provide high peak transmission and high color contrast, along with narrow transition bandwidths and flat profiles. Generally, these filters have spectral properties that are nearly insensitive to the incidence angle.

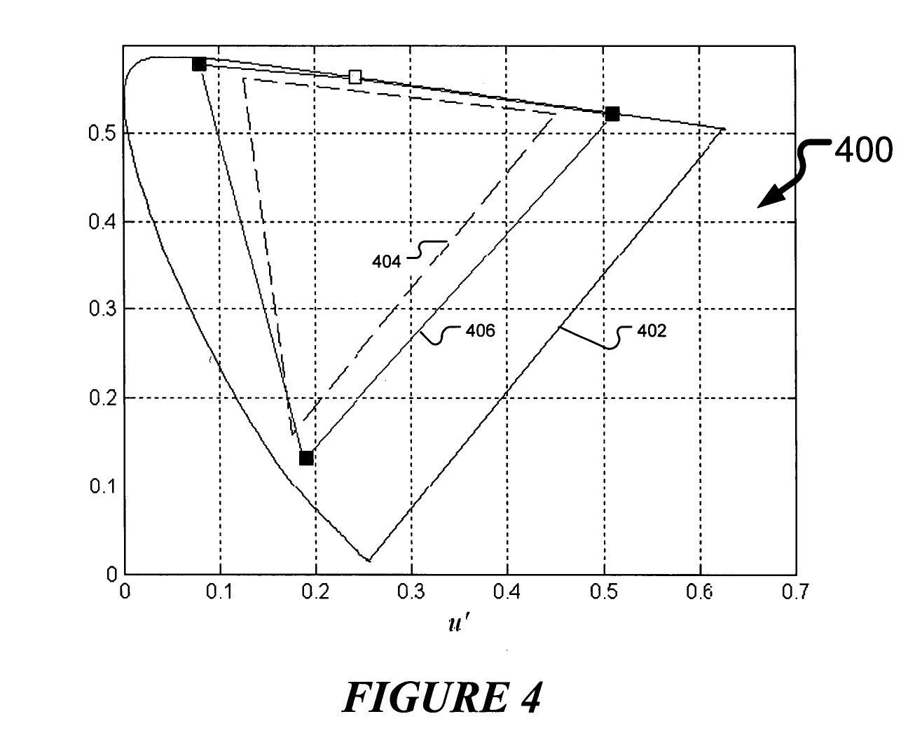

It is difficult to determine the optimum color points in a four-panel system explicitly since there are an infinite number of solutions that encompass any required RGB color gamut. However, if certain target colors are selected that yield good performance, such as the yellow spike around 580 nm, filters can be designed and fabricated to yield an extended color gamut shown in FIG. 4.

FIG. 4 illustrates simulated system color gamuts 400 represented on a graph showing modified color space. As a person of ordinary skill will appreciate, line 402 represents the visual color boundary in a (u′, v′) color space. The graphical representation of (u′, v′) color space is described in further detail in MICHAEL G. ROBINSON ET AL., POLARIZATION ENGINEERING FOR LCD PROJECTION (Wiley & Sons 2005), and is hereby incorporated by reference.

Triangle 404 illustrates a standard three-panel RGB color gamut, and triangle 406 illustrates an extended four-panel gamut. As represented, the extended four-panel gamut triangle 406 shows around a twenty percent increase in the gamut area over that achievable by a conventional three-panel system with a similar 4×PBS architecture. Analysis of the system throughput provides a significant increase in throughput, thus resulting in an increased gamut and brightness. For instance, experimental analysis of the system throughput has shown a throughput of 175% at a 8000K corrected white point, providing a primary lumen ratio R:Y:G:B of 11:40:42:8.

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A projection display system comprising:
a light source operable to generate light having a first color component, a second color component, a third color component, and a fourth color component;
an input beam splitter operable to direct the first and second color components on a first light path, and the third and fourth color components on a second light path;
a first polarizing beam splitter (PBS) with an input port to receive light from the first light path, that directs the first color component toward a first panel, and directs the second color component toward a second panel;
a second PBS with an input port to receive light from the second light path, that directs the third color component toward a third panel, and directs the fourth color component toward a fourth panel;
a third PBS to receive the first and second color component at a first input port, to receive the third and fourth color component at a second input port, and to direct the first, second, third, and fourth color components toward an output port; and
a projection lens for projecting an image from the color components at the output port.

2. The projection display system of claim 1, further comprising:
a first wavelength-selective polarization filter located on the first light path between the input beam splitter and the first PBS;
a second wavelength-selective polarization filter located on the second light path between the input beam splitter and the second PBS;
a third wavelength-selective polarization filter located on a light path between the first PBS and the third PBS; and
a fourth wavelength-selective polarization filter located on a light path between the second PBS and the third PBS.

3. The projection display system of claim 2, wherein the first wavelength-selective polarization filter is a green/magenta filter, the second wavelength-selective polarization filter is a blue/yellow filter, the third wavelength-selective polarization filter is a yellow notch filter, and the fourth wavelength-selective polarization filter is a yellow/blue filter.

4. The projection display system of claim 1, wherein the first and second color components are green and red, or red and green.

5. The projection display system of claim 1, wherein the third and fourth color components are yellow and blue, or blue and yellow.

6. The projection display system of claim 1, wherein the first, second, third, and fourth panels are liquid crystal on silicon displays.

7. The projection display system of claim 1, further comprising a yellow notch wavelength-selective polarization filter and a blue/yellow wavelength-selective polarization filter located on a light path between the light source and the input beam splitter.

8. The projection display system of claim 1, further comprising a yellow notch wavelength-selective polarization filter and a blue/yellow wavelength-selective polarization filter located on a light path between the third PBS and the projection lens.

9. The projection display system of claim 1, further comprising a polarizer on a light path between the light source and the input beam splitter.

10. The projection display system of claim 1, further comprising a polarizer on a light path between the third PBS and the projection lens.

11. A projection display system comprising:
a light source operable to generate light having four color components, wherein each color component comprises a wavelength range;
four light modulators, each of the light modulators generating a respective image associated with each one of the four color components,
a light directing subsystem operable to split the four color components before modulation and recombine them after modulation, wherein each light modulator is located at a separate port of the light directing subsystem; and
a projection lens for projecting an image of the modulated combined color components.

12. The projection display system of claim 11, wherein the four color components comprise red, green, yellow, and blue.

13. The projection display system of claim 11, wherein the light directing subsystem comprises four polarizing beam splitters (PBS).

14. The projection display system of claim 13, wherein the light directing subsystem further comprises four wavelength-selective polarization filters, each filter located on a light path between input and output ports of adjacent PBSs.

15. The projection display system of claim 14, wherein the wavelength-selective polarization filters are selected from the group comprising a green/magenta filter, a blue/yellow filter, a yellow notch filter, and a yellow/blue filter.

16. The projection display system of claim 11, further comprising a polarizer on a light path between the light source and the light directing subsystem.

17. The projection display system of claim 11, further comprising a polarizer on a light path between the light directing subsystem and the projection lens.

18. The projection display system of claim 11, wherein the light modulators are liquid crystal on silicon displays.

19. The projection display system of claim 11, further comprising a yellow notch wavelength-selective polarization filter and a blue/yellow wavelength-selective polarization filter located on a light path between the light source and the light directing subsystem.

20. The projection display system of claim 11, further comprising a yellow notch wavelength-selective polarization filter and a blue/yellow wavelength-selective polarization filter located on a light path between the light directing subsystem and the projection lens.
